(19) United States
(12) Patent Application Publication
(10) Pub. No.: US 2019/0049198 A1
(43) Pub. Date: Feb. 14, 2019

(54) Multi-Nozzle Mechanical Tube Cleaning System

(71) Applicant: Projectile Tube Cleaning, Inc., Ford City, PA (US)

(72) Inventors: Evan Lyle, Ford City, PA (US); Daniel Lyle, Kittanning, PA (US)

(73) Assignee: Projectile Tube Cleaning, Inc., Ford City, PA (US)

(21) Appl. No.: 15/675,179

(22) Filed: Aug. 11, 2017

(51) Int. Cl. F28G 1/12; F28G 1/16; B08B 9/055; F28G 1/08

(52) U.S. Cl. CPC F28G 1/12; F28G 1/163; F16L 2101/12; F28G 1/08; B08B 9/0551

(57) ABSTRACT

The efficiency of projectile tube cleaning in multitube heat exchangers is greatly enhanced by the use of two or more nozzles for pressurized water or other liquid held by a bracket in parallel orientation a distance apart that equals the distance apart of the tubes. A pneumatic control system enables the simultaneous activation of two or more pressurized water valves so that two or more tubes can be scraped clean at once. Large heat exchangers and condensers having ordered arrays of thousands of parallel tubes can be cleaned by selecting a number of tubes for deposition of cleaning projectiles, repeatedly projecting two or more of the projectiles simultaneously, and immediately moving on to another set of tubes; then repeating the process with another selected number of tubes.

### TECHNICAL FIELD

A system is disclosed for cleaning the interiors of tubes in heat exchangers such as condensers and other devices having numerous substantially parallel tubes which periodically become fouled, scaled, or otherwise encumbered with deposits. The system employs projectiles designed to pass through the tubes in close proximity to the interior surfaces of the tubes so that they may remove the deposits with a scraping or abrading action. The projectiles are propelled through the tubes typically with pressurized water at a velocity and force sufficient to insure the removal of the deposits, often in a single pass.

### BACKGROUND OF THE INVENTION

Scale, encrustations, sludge, oxides, and other deposits have virtually always plagued operators of multi-tube heat exchangers and other devices comprised of numerous tubes. The deposits impede the flow of liquids and gases inside the tubes and impair the heat transfer abilities of the tube walls. Many varieties of devices and methods have been proposed for cleaning them. Simple flushing with various solutions is hardly ever sufficient to remove adherent obstacles to the flow of fluids through the tubes, much less calciferous scale, for example, which in even lesser thicknesses can reduce heat transfer abilities significantly. Spheres of various kinds have been used, but provide only minimal contact with the interior surface of the tube. Some systems employ very high pressure (10,000 psi, for example) water, typically delivered through the end of a lance, to “power spray” the internal surfaces. This requires a long attachment and the ability to manipulate it, often with a failure-prone reciprocating mechanism; moreover, the high pressures present unnecessary dangers to the workmen.

A projectile designed specifically for cleaning tube interiors, such as the projectile described by Daniel C. Lyle in U.S. Pat. No. 5,305,488, has proved to be very successful. The design of the projectile includes a cylindrical body and at least two spaced cutters, each having a plurality of cutting blades extending radially from the cutters. Each cutter has a flexible bushing which permits adjustment of the force exerted by the cutter blades. The projectile is sent through the tube with water, generally under pressures of 200-800 psi, much lower than some other systems. One pass-through is virtually always sufficient. The projectiles are collected at the distal ends of the tubes and may be used again many times. They are versatile in that the cutters and scrapers can be of different diameters for use in different size tubes.

A typical heat exchanger or condenser encountered by the cleaning crew may contain from 100 or fewer to 100,000 tubes in an ordered, equally spaced array, all of them ready for cleaning. In a condenser, access to the ends of the tubes is typically gained from the water box, which requires entering through a manhole. The parts of the cleaning equipment that are to be maneuvered by the operators must also pass through the manhole. A heat exchanger may have an enclosure with removable end portions so that the open ends of the tubes are exposed. In either case, the crew will manually insert projectiles at the entrances of a selected number of tubes, perhaps ten percent of them, and then begin the process of propelling them through. This means affixing a specialized “water gun” to the tube openings, one at a time, and activating a valve integral to the water gun to allow pressurized water to propel the projectiles through their respective tubes. More than one gun typically is operated by different members of the crew; other members are positioned to collect the projectiles at the distal ends of the tubes. The valve is activated by a trigger on the gun; the gun with the integral valve is maneuverable, being connected to a hose, but is somewhat awkward, and the operators must repeat the placement and triggering of the gun many times to complete a job.

While the projectile system works well, its implementation, particularly the repeated process of affixing the gun to a tube, triggering the gun, assuring that the projectile passes through the tube, and connecting the gun to the next tube, is laborious and time-consuming.

A more efficient, less time-consuming method of cleaning tubes is needed.

### SUMMARY OF THE INVENTION

The invention enables a worker to purge two or more tubes simultaneously, thus significantly speeding up the tube cleaning process.

One embodiment of the apparatus includes two substantially parallel nozzles held in a desired distance apart by a bracket. Pressurized water is fed to the nozzles on release by a pair of compressed air operated valves which are actuated simultaneously by the operator pushing a button mounted on hand-held pipes feeding the parallel nozzles. Because the nozzles are set at a predetermined distance apart, the operator is able to insert, or affix, them, two at a time, into the ends of tubes that appear in an ordered array on the face of a heat exchanger or condenser. The operator is not encumbered by a bulky water valve on the nozzles, and is able to move the device quickly from one pair of tube ends to another as soon as the first pair has been cleaned.

In addition to the paired embodiment described in the preceding paragraph, the invention includes apparatus comprising three or more nozzles mounted on a bracket, each being an equal distance apart set to correspond to the spacing of the tubes of the heat exchanger to be cleaned.

In addition, the invention includes a method of cleaning tubes in a heat exchanger using projectiles which are propelled through the tubes by water injected simultaneously through two or more tubes. It should be noted that a condenser functions as a heat exchanger, and is a type of heat exchanger. The invention is applicable to any device which employs tubes for heat transfer through the walls of the tubes.

### BRIEF DESCRIPTION OF THE DRAWINGS

FIG. 1 is an open outline-perspective representation of a multi-tube heat exchanger of the type to be cleaned by the invention.

FIG. 2 shows a prior art tube injector having an integral water valve.

FIG. 3 is an overhead view of a double injector of the invention when in operation.

FIG. 4 provides a frontal view of the double injector of the invention when in operation.

FIG. 5 is a side view of the double injector of the invention.

FIG. 6 shows the inside of a portable cabinet for housing the air-operated water valves of the invention.

FIG. 7 is a simplified flow diagram of the invention.

### DETAILED DESCRIPTION OF THE INVENTION

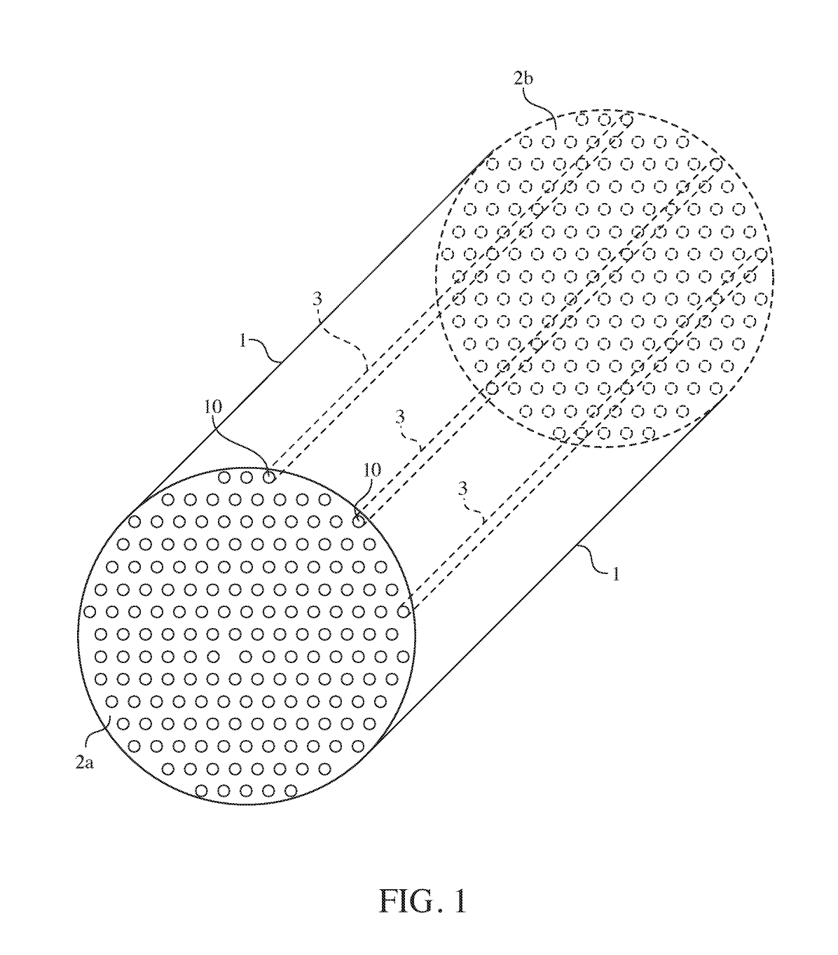

Referring first to FIG. 1, a common structure for a multi-tube heat exchanger or the like has a cylindrical shell 1, circular faces 2a and 2b, and a large number of tubes 3 extending from face 2a to face 2b. Such a cylindrical shape is common, but heat exchangers, including especially condensers, may be box-shaped, having rectangular faces, or oval faced. The invention is for use in all such heat exchangers, as they will have evenly spaced arrays of tubes as shown, the ends of which are accessible in various ways for cleaning with projectiles. Various types of covers or manifolds for delivering fluid to and removing it from the tubes (these are not shown), may enclose the structure when in use. When the tubes are to be cleaned, the covers, manifolds or the like will have been removed, exposing the ends of the tubes 3 as shown. FIG. 1 is presented primarily to show a typical pattern of the open ends of the tubes in such heat exchangers, which may contain commonly perhaps 25,000 tubes, but may have from 100 or fewer to as many as 100,000 tubes, almost always of the same length and internal diameter.

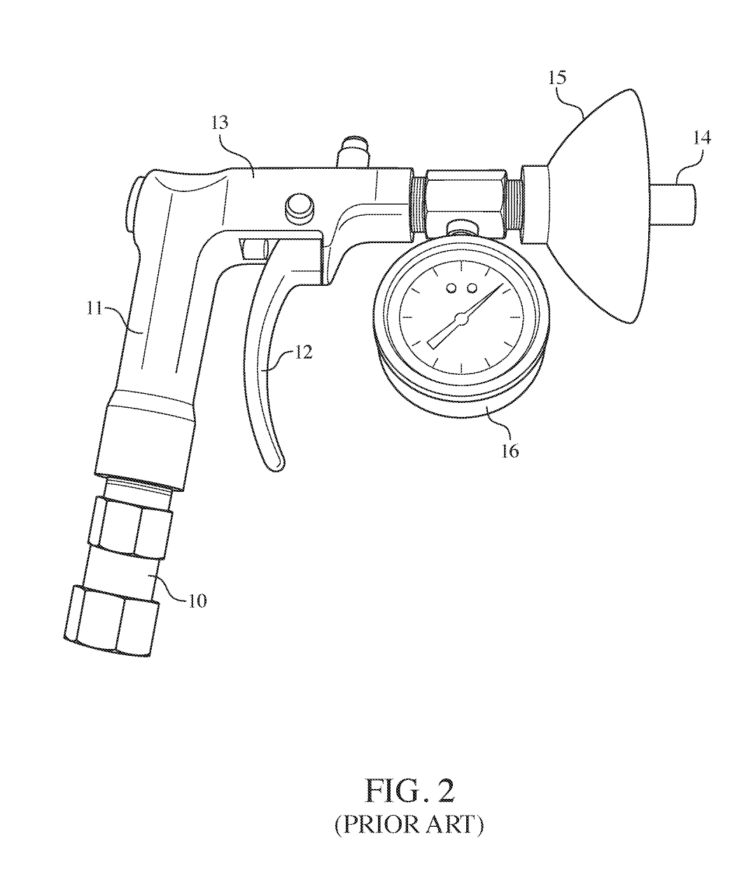

Tubes 3 are equidistant from and parallel to each other, and are set in rows. In this configuration, which is common, the rows of tubes 3 are all the same distance apart and it should be noted that, in this typical case, the ends of any three tubes form equilateral triangles with tube ends in the same and adjacent rows. Thus each tube, except those on the edges of faces 2a and 2b, is the center of a hexagon of tubes, each of them equidistant. When the tubes are to be cleaned, a cleaning projectile—for example one described in the aforementioned Lyle U.S. Pat. No. 5,305,488, which is hereby incorporated herein in its entirety—is placed in the open end of each tube to be cleaned. Often, only a portion of the tubes—10%, for example—will be set with projectiles; a group may be selected for efficient access from a certain position, or a limited number may be set simply because it is inconvenient to carry and place hundreds or thousands of projectiles at once. According to the process of the prior art, a nozzle/gun similar to the one illustrated in FIG. 2 is inserted sequentially into each of the tube ends and discharged to propel the projectiles through the tubes one at a time. As will be seen, the invention enables the cleaning of two or more tubes simultaneously, thus considerably increasing the productivity of the cleaning crew.

In FIG. 2, a prior art tube injector is shown. The injector has a connector 10 for a pressurized water source, and a conduit 11 for the pressurized water; conduit 11 also serves as a handle. Trigger 12 opens a valve within stem 13, permitting pressurized water to proceed to nozzle 14, which will have been inserted into a tube containing a projectile. Nozzle 14 is usually surrounded by a cup-shaped, conical or campanulate splash guard 15, which may be made of a flexible material. A pressure monitor 16 is provided to enable the operator to observe the water pressure in the nozzle as the projectile travels through the tube; normally, a reduction in pressure may be seen when the projectile leaves the distal end of the tube. It should be evident to the reader that this procedure requires inserting the nozzle and pulling the trigger for each individual tube, meaning hundreds or many thousands of times, a tiring and time-consuming process.

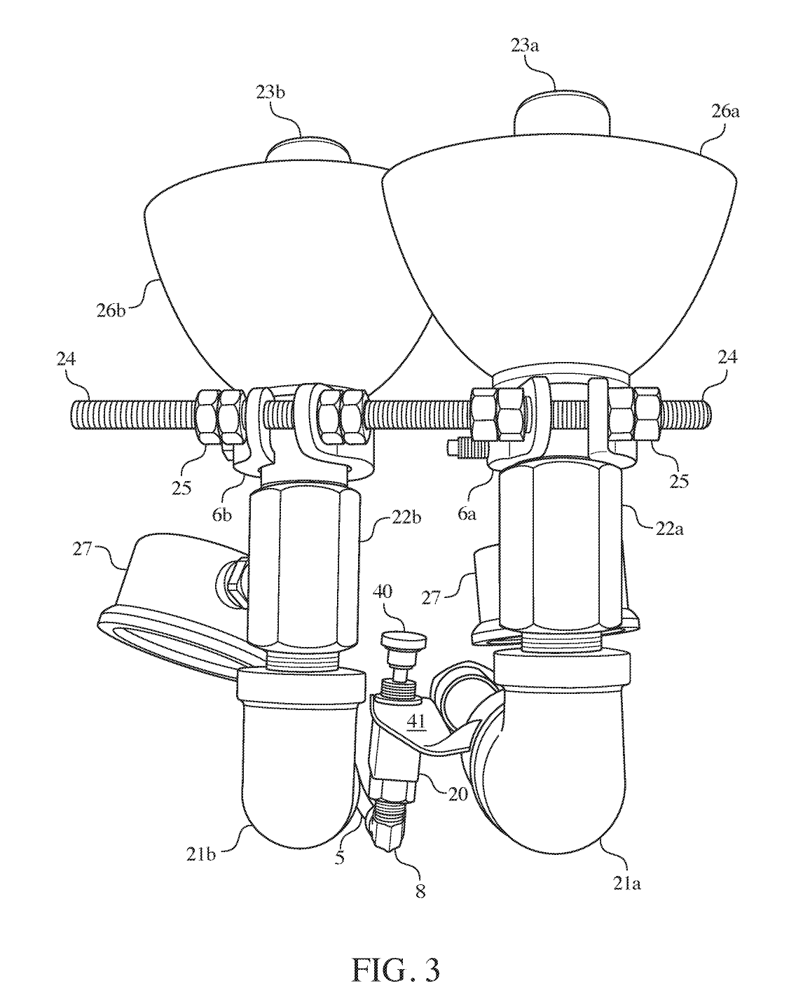

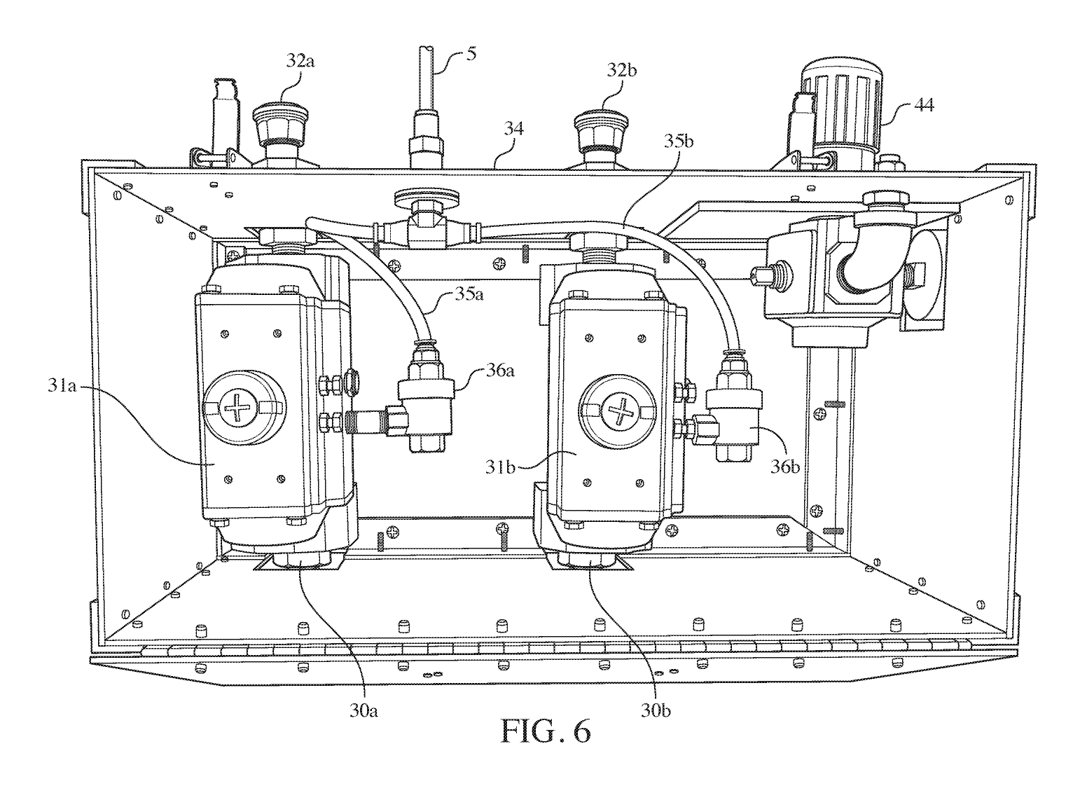

Referring now to FIG. 3, an overhead view of a pair of injectors is shown. Air valve 20, set in compressed air line 5 with connector 8, has a button 40 which, when depressed, simultaneously activates water control valves 31a and 31b (see FIG. 6) to permit water or other liquid to flow into elbows 21a and 21b, through gauge adaptors 22a and 22b, and into nozzles 23a and 23b which, in performance of the cleaning process would be inserted into two adjacent tubes containing cleaning projectiles. Air valve 20 is mounted on a support 41. It will be noted that the two nozzles 23a and 23b are oriented substantially parallel to each other; this is accomplished by a threaded bracket 24 which includes clamps 6a and 6b below gauge adaptors 22a and 22b. The distance between the nozzles may be adjusted for various heat exchangers using nuts 25 on bracket 24. Any other kind of suitable adjustable but rigid bracket may be used. Cup-like splash guards 26a and 26b, which may be made of a flexible material, are fixed above the ends of nozzles 23a and 23b in any suitable manner. Pressure readouts 27 may be provided so the operator may monitor the pressure in each nozzle, especially to determine when the subject projectile has emerged from the distal end of a tube.

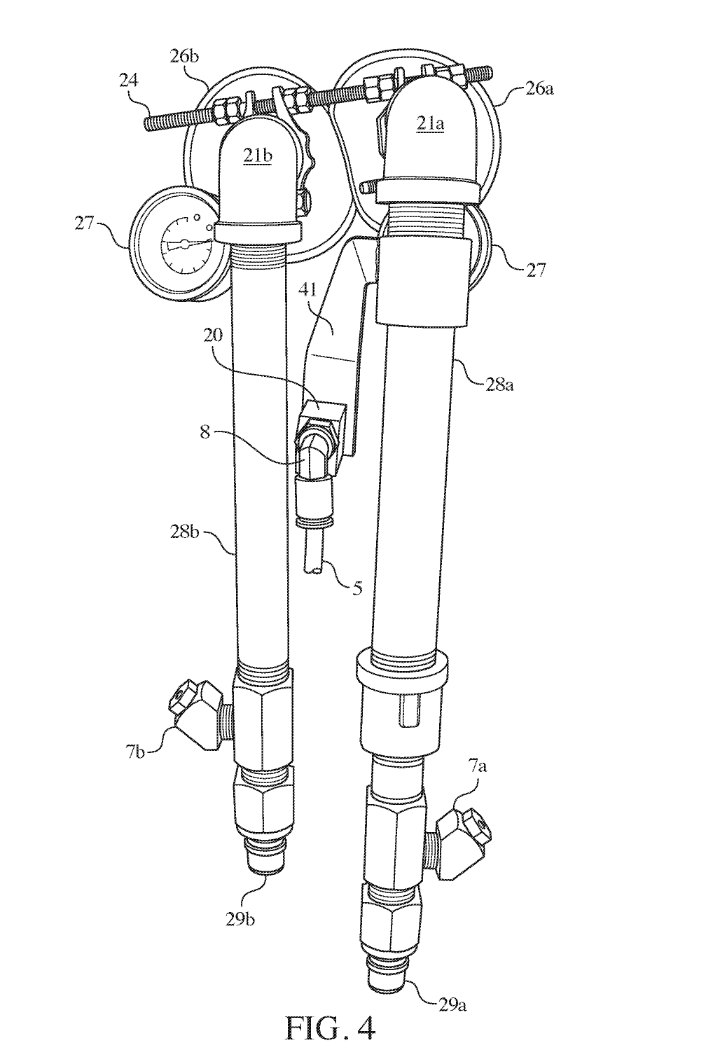

In the FIG. 4 frontal view of the paired nozzles of FIG. 3, elbows 21a and 21b are seen to be above splash guards 26a and 26b, and are associated with pressure readouts 27. Adjustable bracket 24 holds the two nozzle assemblies together at a desired fixed distance apart. Pipes 28a and 28b carry pressurized water or other liquid from hookups 29a and 29b, which are connected to a pressurized source to be described in FIG. 6. Pipes 28a and 28b serve together as a handle. Pipes 28a and 28b may be fitted with vacuum breakers 7a and 7b. Between pipes 28a and 28b is air valve 20, handy to the user. Button 40 (See FIG. 3), when depressed, activates air valve 20 to open compressed air line 5 having connector 8, which immediately activates air-operated control valves 31a and 31b (see FIG. 6) to send pressurized water through the both pipe and nozzle assemblies simultaneously.

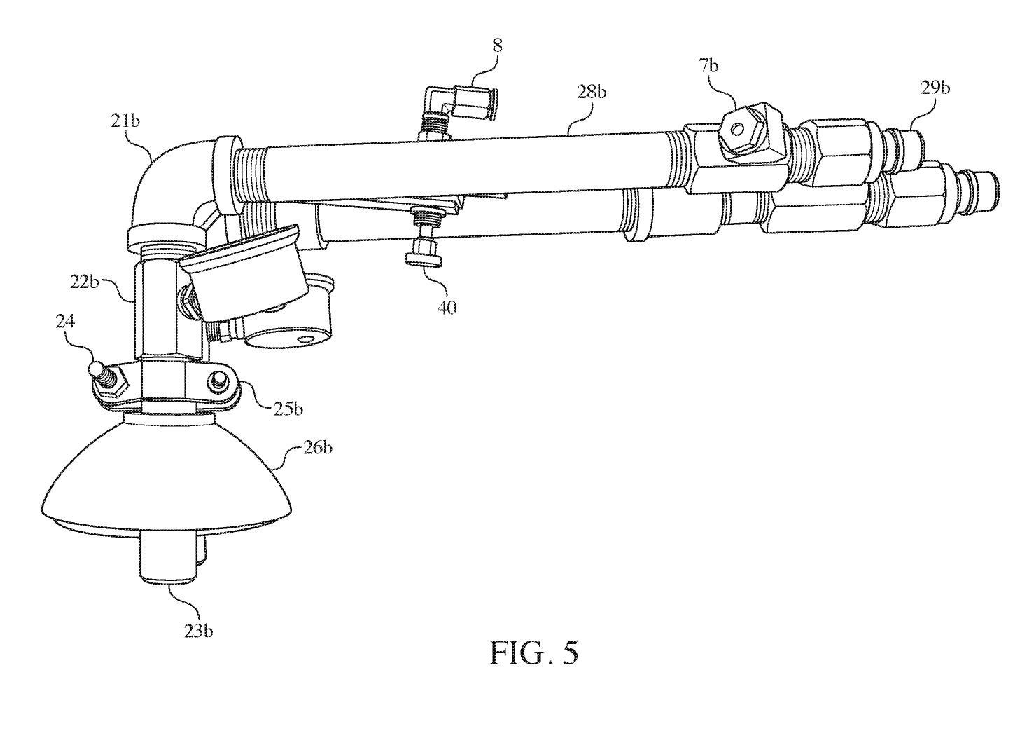

FIG. 5 is a side view of the paired injectors of FIGS. 3 and 4. Referring only to the nearest injector, elbow 21b connects to gauge adaptor 22b which leads to nozzle 23b surrounded by splash guard 26b. Clamp 25b assures the proper placement of the nozzles on bracket 24. Also connected to elbow 21b is pipe 28b which is connected to a water source (not shown) at hookup 29b. As described with respect to FIG. 4, pipe 28b and its twin pipe 28a serve as a handle for the operator. Between them are shown the air line connector 8 for air valve 20 (behind pipe 28b: see FIGS. 3 and 4) and its button 40.

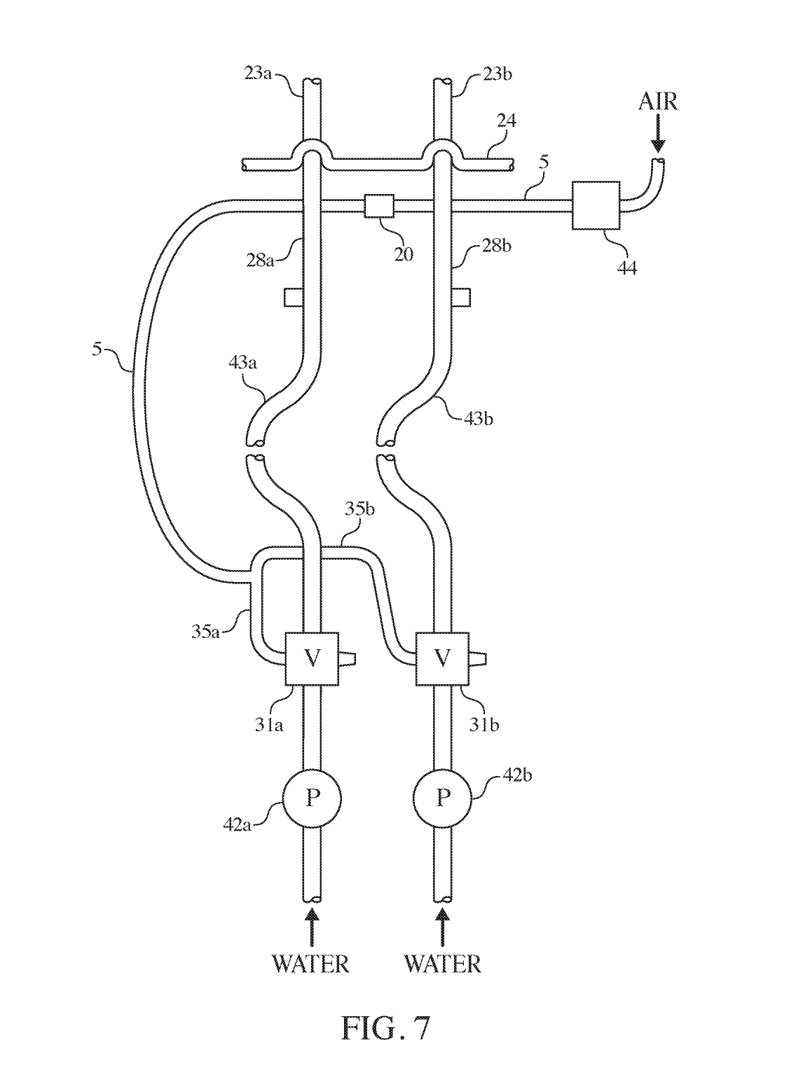

FIG. 6 is an overhead view of a portable cabinet which can be used conveniently to implement the invention. The top of the cabinet has been removed in this view to show water intake fittings 30a and 30b for admitting water from separate pumps (not shown) to respective control valves 31a and 31b. Each control valve has an outlet, seen as 32a and 32b, to be connected to a pair of injectors such as illustrated in FIGS. 3, 4, and 5. Compressed air line 5 passes through cabinet wall 34 to a fitting for lines 35a and 35b, passing into control valves 31a and 31b respectively; each of lines 35a and 35b has a quick air exhaust valve 36a and 36b in association with its respective control valve; these air exhaust valves assure that, when passage of a projectile through a tube is complete, water flow will be discontinued so the nozzles may be moved to the next pair of tubes with a minimum of splash. Any convenient source can be used for the compressed air; usually the cleaning crew will be able to connect to the plant system, and a regulator 44 (see FIG. 7 for its placement in the air line) is included to ensure a steady pressure. If a plant system is not available, a small compressor can be brought into the site.

FIG. 7 is a simplified flow diagram for the invention having two nozzles. Pumps 42a and 42b provide water through fittings 30a and 30b (see FIG. 6) to control valves 31a and 31b. When control valves 31a and 31b are open, water passes through flexible conduits 43a and 43b to pipes 28a and 28b and then to nozzles 23a and 23b, where it is injected into the adjoining heat exchanger tubes, not shown. The two nozzles 23a and 23b are maintained at a specified distance apart by adjustable bracket 24. A compressed air supply line 5 originates from a plant or other compressor and passes through a regulator 44 before arriving at air valve 20. As is known in the pneumatic control art, the regulator will assure a stable source of pressurized air. The compressed air line 5 then is split into air lines 35a and 35b, terminating at control valves 31a and 31b. When button 40 (see FIGS. 3 and 5) on air valve 20 is depressed, the compressed air causes control valves 31a and 31b to open, sending water to both nozzles at once. The support (seen as support 41 in FIG. 3), for valve 20 with its button 40, may optionally span both pipes 28a and 28b, thus acting to reinforce bracket 24 in its function of maintaining an appropriate spacing between nozzles 23a and 23b. Where three nozzles are to be used, a separate parallel set of parts comprising another nozzle at a set distance apart on bracket 24, a pipe, a flexible conduit, control valve and pump are added and connected to a water supply, and air line 5 is split into three ends so the third control valve may be operated simultaneously with the others. Additional nozzles may be supplied with pressurized water by similar additional assemblies.

In the usual practice of the invention, the ends of the tubes in the heat exchanger are exposed as exemplified in FIG. 1, and cleaning projectiles (for example, the projectiles described in Lyle U.S. Pat. No. 5,305,488) are placed in the open ends of a selected number of adjacent tubes. The water connections and air line fittings are secured and the pumps are turned on. The operator first manipulates the nozzles of a pair of injectors such as illustrated in FIGS. 3, 4, and 5 into two adjacent tubes and then activates the air valve by pushing button 40, causing the pneumatic system to open the water valves 31a and 31b, which sends pressurized water into the nozzles 23a and 23b and further into the two adjacent tubes, propelling the respective projectiles through the tubes to scrape them clean. After the projectiles emerge from the distal ends of the tubes, the operator moves the nozzles to a new pair of tubes and repeats the process. The operator's productivity is thus doubled compared to the prior art process. It should be noted that the paired injectors need not be held horizontally—they can be held at an angle so that two rows of tubes are cleaned as the paired device is moved across the face of the heat exchanger. Projectiles collected at the distal ends of the tubes are collected and, after the first selected number of tubes has been cleaned—say, ten percent of the tubes—another cluster of perhaps ten percent of the tube ends is set with projectiles and cleaned in the same manner.

Bracket 24 may be made longer than shown in the figures so that three or more injectors can be accommodated, preferably in a row rather than in a triangular configuration, although a triangular configuration will also be beneficial. There is no reason why four or more nozzles could not be accommodated on a linear bracket, provided that each nozzle has its own pressurized water supply. Although I believe simultaneous cleaning is most beneficial, if for some reason an operator would want to activate the water valves sequentially, an appropriate valve control device could be used.

The pneumatic control system may be replaced by an electric one; however, because water may occasionally escape the system more or less uncontrolled, a pneumatic system is preferred for safety reasons. A wireless system, operated by a touch control in place of button 40, would require a tightly waterproof remote control. Nevertheless, electric controls for the valves are contemplated within the invention.

In describing the invention, I have sometimes used the term “liquid” instead of water. It should be understood that the apparatus and method function in the same way whether the liquid is one other than water—for example, it may for some reason be called a cleaning solution or a purge, or it may carry dissolved or particulate matter and thus be called something other than “water.” For purposes of the operation of the invention, all such terms are equivalent.

Thus, the invention includes tube cleaning apparatus for cleaning tubes in a heat exchanger, where the tubes are parallel to each other in an equally spaced ordered array comprising (a) at least two injection nozzles for connection to at least two tube openings (b) a mounting bracket holding the injection nozzles in substantially parallel orientation, and (c) separate conduits connected to the injection nozzles for providing liquid thereto, the mounting bracket and the injection nozzles being configured to match the spacing of tubes in the ordered array. By matching the spacing in the ordered array, I mean to include possibly matching the spacing between rows, between adjacent tubes, spacing between tube ends at an angle, and possibly even every other tube end. Three nozzles may be held in a linear or triangular configuration; four or more nozzles are conveniently in a linear arrangement.

The invention also includes a method of cleaning tubes in an ordered array of tubes in a heat exchanger comprising (a) inserting cleaning projectiles into the ends of selected tubes therein, (b) affixing nozzles to at least two adjacent ends of the tubes containing cleaning projectiles, and (c) propelling the cleaning projectiles in the at least two adjacent tubes containing cleaning projectiles by simultaneously activating control valves, thereby conducting liquid under pressure from the nozzles into the tubes and forcing the projectiles through the tubes.

1. Tube cleaning apparatus for cleaning tubes in a heat exchanger, said tubes being parallel to each other in an equally spaced ordered array, said apparatus comprising (a) at least two injection nozzles for connection to at least two tube openings (b) a mounting bracket holding said injection nozzles in substantially parallel orientation, and (c) separate conduits connected to said injection nozzles for providing liquid thereto, said mounting bracket and said at least two injection nozzles being configured to match the spacing of tubes in said ordered array.

2. The tube cleaning apparatus of claim 1 wherein said mounting bracket is adjustable to vary the spacing between said nozzles.

3. The tube cleaning apparatus of claim 1 including a substantially cup-shaped splash guard on each of said nozzles.

4. The tube cleaning apparatus of claim 1 including a pump for separately pumping said liquid in each of said separate water conduits.

5. The tube cleaning apparatus of claim 4 including a control valve on each of said water conduits for starting and stopping the flow of liquid to said nozzles.

6. The tube cleaning apparatus of claim 5 wherein said control valves are operated by compressed air.

7. The tube cleaning apparatus of claim 6 including an air valve adapted to open and close said control valves simultaneously.

8. The tube cleaning apparatus of claim 7 including an air exhaust valve associated with each of said control valves.

9. The tube cleaning apparatus of claim 6 including a regulator for said compressed air.

10. Method of cleaning at least two tubes in an ordered array of tubes in a heat exchanger comprising (a) inserting cleaning projectiles into the ends of at least two adjacent tubes (b) affixing nozzles to at least two of the ends of said at least two adjacent tubes containing cleaning projectiles, and (c) simultaneously propelling the cleaning projectiles in said at least two adjacent tubes containing cleaning projectiles by simultaneously activating control valves using compressed air, thereby conducting liquid under pressure from said nozzles to pass into said tubes.

11. Method of claim 10 wherein said nozzles in step (b) are held at a fixed distance apart substantially equal to the distances apart of said tubes.

12. Method of claim 11 wherein said nozzles are held by a bracket at said fixed distance apart.

13. Method of claim 12 wherein said fixed distance apart is adjustable.

14. Method of claim 10 wherein said nozzles comprise three tube injectors held at fixed and equal distances apart.

15. Method of claim 14 wherein said nozzles at fixed and equal distances apart are held on a linear bracket.

16. Method of claim 10 wherein, in step (c), said valves are activated simultaneously using a common source of compressed air.

17. Method of claim 10 wherein said liquid is water.

18. Method of claim 10 wherein said heat exchanger contains from 100 to 100,000 tubes and wherein steps (a), (b) and (c) are repeated on adjacent pairs of tubes until all of said tubes are cleaned.

19. Method of cleaning tubes in an ordered array of tubes in a heat exchanger comprising (a) inserting cleaning projectiles into the ends of selected tubes therein (b) affixing nozzles to at least two ends of said tubes containing cleaning projectiles, and (c) simultaneously propelling the cleaning projectiles in said at least two tubes containing cleaning projectiles by simultaneously activating control valves, thereby conducting liquid under pressure from said nozzles into said tubes forcing said projectiles through said tubes.

20. Method of claim 19 comprising repeating steps (a), (b), and (c) until all of the tubes in said heat exchanger are cleaned.
